(19) United States
(12) Patent Application Publication
(10) Pub. No.: US 2005/0227672 A1
(43) Pub. Date: Oct. 13, 2005

(54) System, apparatus and method for wireless notification

(76) Inventors: Roch Lauzon, Gatineau (CA); Normand A. Clermont, St-Hubert (CA); Laxmanbhai D. Mistry, Oakville (CA)

Correspondence Address: TORYS LLP, 79 WELLINGTON ST. WEST, SUITE 3000, TORONTO, ON, M5K 1N2, CA

(21) Appl. No.: 11/002,149

(22) Filed: Dec. 3, 2004

(30) Foreign Application Priority Data
Dec. 18, 2003 (CA) 2,453,709

(51) Int. Cl. H04Q 7/20

(52) U.S. Cl. 455/412.2; 455/428

(57) ABSTRACT

The present invention is a system and method for wireless emergency notification. In embodiments, a Civic Notification Service Centre (CNSC) generates a notification message, the notification message including a location identifier and notification information. The location identifier represents a geographical area such as a postal code, city street, neighborhood, or municipality. The CNSC transmits the notification message to a message switch that translates the location identifier to at least one device identifier such as a CAP code that is allocated to a set of notification devices assigned to the geographical location defined by the location identifier. Alternatively, the device identifier could be directly input within the notification message. After translation, the resulting notification message is transmitted to a set of base stations which subsequently transmit the notification message to a plurality of notification devices. The notification devices programmed with the device identifier within the notification message process the notification information. In some cases, a select set of base stations could be defined to transmit a notification message and therefore a limited wireless coverage area would be used that primarily focuses on the geographical area defined by the location identifier of the message. This notification system allows for the bypassing of the PSTN which ensures that in times of emergency, when the PSTN tends to be over-loaded, the notification message can still be delivered to the appropriate notification devices.

### FIELD OF THE INVENTION

The present invention relates generally to a system, apparatus and method for communication of notifications and more specifically to delivery of wireless notifications to devices within a pre-determined geographical area.

### BACKGROUND OF THE INVENTION

Traditionally, government agencies, regional and municipal authorities have relied on audio sirens, door-to-door notifications, TV and radio broadcasts as means for notifying the general public of immense or forthcoming emergencies, such as chemical, gas or nuclear spills; severe weather conditions or other hazardous conditions. Generally, these methods prove to be ineffective. Sirens, while notifying the public of an emergency, do not specify the nature of the emergency nor the affected territory. TV and radio broadcasts can provide further details on the nature of emergency, but may be hard to draw attention to or be unavailable in the case of a power failure.

Increasingly, government organizations at the federal, provincial and municipal level are looking for an affordable and effective system for notifying residents in a particular area of civic emergencies, which would enable them to communicate the fact of an emergency, its nature and proposed course of actions.

U.S. Pat. No. 6,462,665 filed on May 16, 2000 by Tarlton et al, assigned to Wheelock Inc. of Long Branch, N.J. (hereinafter referred to as Tarlton) discloses a method and apparatus for sending a severe weather alert, utilizing a paging type system having dedicated frequencies for transmissions. In the Tarlton system, a pager receiver is utilized. The notification device is assigned to a particular geographical area. The set of notification devices in a particular area are assigned a common telephone number. When a weather warning is received, the system dials the specific phone number or numbers for transmitting a warning to the alert units in the affected area.

One of the problems with the Tarlton solution is that it utilizes the public switched telephone network to connect to the notification device. The problem is two-fold. Firstly, a telephone number or combination of telephone numbers is required to identify sets of emergency notification devices in a particular gographical area. This puts an excessive burden on the telephone number availability. Since the available numbers are limited by definition, there could be insufficient numbers to cover all combinations of emergency notification devices required. Yet another problem with using the PSTN is that in case of emergency, the PSTN tends to be overloaded with callers, trying to get hold of their relatives, and friends to notify them of the emergency situation. If the PSTN gets overloaded, it could become difficult to initiate the emergency notification delivery and provide updates to the public, as the notification number might not be reachable.

U.S. Pat. No. 6,177,873 filed on Feb. 8, 1999 by Cragun, assigned to International Business Machines Corporation (hereinafter referred to as Cragun) discloses an apparatus and associated method for notifying users when weather alerts are issued according to geographical areas of interest. The geographical area and weather notification parameters are set by the user. When the weather alert is detected, it is transmitted by the base station to all available emergency notification devices. The message contains specific weather notification parameters. When a message is received on a particular emergency notification device, the notification parameters are compared to the pre-selected parameters of interest for that particular device (e.g. geographical area, types of warnings, etc) and all unwanted messages are ignored. The emergency notification device only displays those notifications that fall within the user selected criteria.

One of the shortcomings of the above solution is the requirement that the user input the parameters utilized for filtering the incoming message to be displayed, including the geographic areas of interest. This requirement adds considerable costs to produce and maintain the notification devices while leaving the possibility for misconfigurations of the apparatus. Due to the severe importance of these devices in times of emergency, misconfigurations should be minimized. A further shortcoming exists within the system of the Cragun patent in the combination of the mass broadcasting of the notification messages with the control of the device being in the hands of the user. The combination of features makes these devices portable and adjustable, both features are not ideal in circumstances that these notification devices are purchased for specific dwellings for specific emergency utilization.

### SUMMARY OF INVENTION

The present invention, according to a first broad aspect, is a system for delivering notification information to a set of notification devices. The system comprises a notification message apparatus, a transport network coupled to the notification message apparatus and a set of notification devices. The notification message apparatus is operable to generate and transmit a notification message comprising at least one device identifier and notification information, each device identifier being allocated to a set of notification devices assigned within a geographical area. The transport network is operable to receive the notification message and to transmit the notification message to a wireless coverage area. The set of notification devices is within the wireless coverage area and is operable to receive the notification message from the transport network and to process the notification information if one of the at least one device identifier corresponding to the notification message is allocated to the particular set of notification devices.

In a further aspect, within the system of the first broad aspect, the transport network comprises a plurality of base stations, each base station having a corresponding base station identifier. In this aspect, the notification message further comprises a set of base station identifiers that collectively define the wireless coverage area of the transport network for transmitting the translated notification message. Hence, the notification information is not transmitted by all base stations within the transport network and only by a select set of base stations that limits the geographical area of the transmission. In one embodiment of this aspect, the system further comprises a base station allocation apparatus operable to receive the notification message, to determine a set of base station identifiers that collectively define the wireless coverage area of the transport network for transmitting the notification message and to input the set of base station identifiers into the notification message.

The set of base station identifiers could comprise one or more base station identifiers. Further, the set of notification devices could comprise one or more notification devices.

In yet a further aspect, each of the notification devices within the set of notification devices are allocated a plurality of device identifiers. For each notification device, the allocated device identifiers represent a plurality of geographical areas in which the notification device is physically located. In some embodiments, the system of the first broad aspect comprises a remote device identifier allocation apparatus operable to transmit, via the transport network, at least one device identifier to at least one notification device of the set of notification devices in order to allocate the at least one device identifier to the notification device. This allocation could be based upon a primary device identifier that is permanent for the notification device.

The present invention, according to a second broad aspect, is a method for delivering notification information to a set of notification devices. The method comprises: generating a notification message comprising at least one device identifier and notification information, each device identifier being allocated to a set of notification devices assigned within a geographical area; transmitting the notification message to a wireless coverage area; receiving the notification message at the set of notification devices; and processing the notification information at each of the notification devices if one of the at least one device identifier corresponding to the notification message is allocated to the particular notification device.

The present invention, according to a third broad aspect, is a system for delivering notification information to a set of notification devices. The system comprises a translation apparatus, a transport network and a set of notification devices. The translation apparatus is operable to receive a notification message comprising at least one location identifier and notification information; to determine, for each of the at least one location identifiers, at least one corresponding device identifier, each device identifier being allocated to a set of notification devices assigned within a geographical area defined by the location identifier; and to generate a translated notification message comprising the at least one device identifier and the notification information. The transport network is coupled to the translation apparatus and is operable to transmit the translated notification message to a wireless coverage area The set of notification devices is within the wireless coverage area and is operable to receive the translated notification message from the transport network and to process the notification information if one of the at least one device identifiers within the translated notification message is allocated to the particular set of notification devices.

According to a fourth broad aspect, the present invention is a method for delivering notification information within a set of notification devices. The method comprises: receiving a notification message comprising at least one location identifier and the notification information; translating each of the at least one location identifiers into at least one device identifier in order to generate a translated notification message, each device identifier being allocated to a set of notification devices assigned within a geographical area defined by the location identifier; transmitting the translated notification message to a wireless coverage area; receiving the translated notification message at a set of notification devices within the wireless coverage area; and processing the notification information if one of the at least one device identifiers corresponding to the notification message is allocated to the particular set of notification devices.

According to a fifth broad aspect, the present invention is an apparatus for translating notification messages. The apparatus comprises first and second interfaces and a processing unit. The first interface is operable to receive a notification message comprising at least one location identifier and the notification information. The processing unit is operable to determine, for each of the at least one location identifiers, at least one corresponding device identifier, each device identifier being allocated to a set of notification devices assigned within a geographical area defined by the location identifier; and to generate a translated notification message comprising the at least one device identifier and the notification information. The second interface is operable to output the translated notification message to a set of notification devices within a wireless coverage area. The first and second interfaces could be integrated within a single interface.

According to a sixth broad aspect, the present invention is an apparatus for generating notification messages to be transmitted to a set of notification devices. The apparatus comprises a notification information interface operable to receive notification information; a device identifier interface operable to receive at least one device identifier, each device identifier being allocated to a set of notification devices assigned within a geographical area; a processing unit operable to generate a notification message comprising the notification information and the at least one device identifier; and an output interface operable to output the notification message to a transport network for delivery to the set of notification devices corresponding to the at least one device identifier. The notification information interface and the device identifier interface could be integrated within a single web portal interface.

According to a seventh broad aspect, the present invention is a method for generating notification messages to be transmitted to a set of notification devices. The method comprises: receiving notification information; receiving at least one device identifier, each device identifier being allocated to a set of notification devices assigned within a geographical area; generating a notification message comprising the notification information and the at least one device identifier; and outputting the notification message to a transport network for delivery to the set of notification devices corresponding to the at least one device identifier.

According to an eighth broad aspect, the present invention is an apparatus for generating notification messages to be transmitted to a set of notification devices. The apparatus comprises a notification information interface operable to receive notification information; a location identifier interface operable to receive at least one location identifier, each location identifier defining a geographical area in which a set of notification devices are assigned; a processing unit operable to generate a notification message comprising the notification information and the at least one location identifier; and an output interface operable to output the notification message to a transport network for delivery to the set of notification devices within the geographical area defined by the at least one location identifier. The notification information interface and the location identifier interface could be integrated within a single web portal interface.

The present invention, according to a ninth broad aspect, is a method for generating notification messages to be transmitted to a set of notification devices. The method comprises: receiving notification information; receiving at least one location identifier, each location identifier defining a geographical area in which a set of notification devices are assigned; generating a notification message comprising the notification information and the at least one location identifier; and outputting the notification message to a transport network for delivery to the set of notification devices within the geographical area defined by the at least one location identifier.

According to a tenth broad aspect, the present invention is a system for remotely assigning a device identifier to at least one notification device. The system comprises a device identifier allocation apparatus, a transport network and at least one notification device. The device identifier allocation apparatus is operable to generate and transmit a device identifier message comprising at least one primary device identifier associated with a predetermined notification device and at least one secondary device identifier allocated to a geographical area in which the predetermined notification device is located. The transport network is coupled to the device identifier allocation apparatus and is operable to receive the device identifier message and to transmit the device identifier message to a wireless coverage area. The at least one notification device is within the wireless coverage area and is operable to receive the device identifier message from the transport network and to allocate the at least one secondary device identifier to the notification device if the notification device is allocated the primary device identifier.

The present invention, according to an eleventh broad aspect, is a method for assigning device identifiers to at least one notification device. The method comprises: generating a device identifier message comprising at least one primary device identifier associated with a predetermined notification device and at least one secondary device identifier allocated to a geographical area in which the predetermined notification device is located; transmitting the device identifier message to at least one notification device within a wireless coverage area; and allocating the at least one secondary device identifier to the notification device if the notification device is allocated the primary device identifier.

### BRIEF DESCRIPTION OF THE DRAWINGS

Embodiments of the present invention are described with reference to the following figures, in which:

FIG. 1 is a block diagram illustrating a notification system architecture according to one embodiment of the present invention;

FIGS. 2A and 2B are diagrams illustrating flow of messages between components of FIG. 1 according to two embodiments of the present invention;

FIG. 3 is a pictorial diagram illustrating the flow of messages according to one embodiment of the present invention;

FIGS. 4A and 4B are block diagrams illustrating the notification device in a first and a second embodiment of the present invention respectively;

FIG. 5 is a flow chart illustrating the process steps, performed within the notification device in FIGS. 4A and 4B;

FIG. 6A is a block diagram illustrating the CNSC of FIG. 1 according to one embodiment of the present invention; and

FIGS. 6B and 6C are pictorial diagrams of Graphical User Interfaces (GUIs) used within the CNSC of FIG. 6A according to first and second embodiments of the present invention.

### DETAILED DESCRIPTION OF THE PREFERRED EMBODIMENT

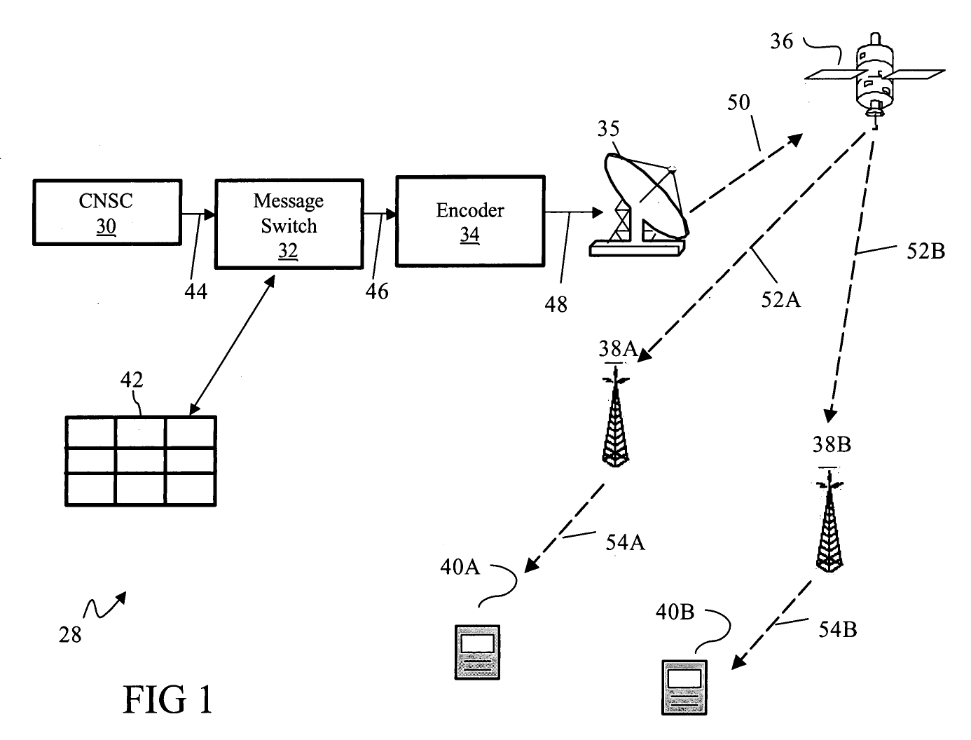

FIG. 1 depicts a block diagram of a wireless civil notification system according to one embodiment of the present invention. In this embodiment, a notification network 28 comprises a Civil Notification Service Centre 30 (hereinafter referred to as the CNSC), a message switch 32 coupled to the CNSC 30 and an encoder 34 coupled to the message switch 32. The network 28 further comprises a communication satellite 36 operable to communicate with the encoder 34 and a plurality of base stations 38A, 38B, operable to communicate with the communication satellite 36. Within the network 28, there is a plurality of notification devices 40A, 40B that are operable to receive communications from one or more of the base stations 38A, 38B.

The overall network 28 is operable to communicate a notification message from the CNSC 30 to the notification devices 40A, 40B. In one embodiment of the present invention, the notification message comprises a message header and a message body. The message header includes information concerning the location of the affected area (hereinafter referred to as a location identifier). The location identifiers are any indications that can identify a specific geographic area; such as a plurality of dwellings, a street, a set of streets within a municipality or a municipality itself. In one embodiment of the present invention, a postal code is used to identify geographical areas. A person skilled in the art will appreciate that other identifiers could be used with various different sizes of geographical areas being grouped together.

The message body comprises notification information. This notification information could include a civil emergency alert, such as a notification of a chemical spill or a nuclear plant meltdown. Alternatively, the notification information could include information of concern with respect to, but not limited to, weather conditions, road conditions, public transport alerts and/or proposed courses of action. In other embodiments, the notification information comprises text to be displayed on an alphanumeric display, text to speech data or an audio message file to be played. One should understand that other information that requires localized distribution could also be included within the notification message body.

In some embodiments of the present invention, the message body and/or message header further includes an identifier of the severity of the condition (hereinafter referred to as a severity indication). The severity indication identifies how severe the reported emergency condition is and is used to trigger a particular set of actions within the appropriate notification devices. In one embodiment, the severity identifier comprises code “Red”, “Orange” and “Yellow” within the message body. In another embodiment, the severity indication comprises numeric identifiers, such as 1, 2 and 3. It should be clear to a person skilled in the art, that other types of severity indications could be used.

The CNSC 30 is the source of notification messages, though it should be understood that other components not shown could allow notification messages to be received at the CNSC 30 from another location. The CNSC 30 is operable to communicate the notification message to the message switch 32. For simplicity, communication links between the CNSC 30 and the message switch 32 have been omitted from the drawing. In one embodiment, the connection is a secure connection. A person skilled in the art will appreciate that microwave, IP connectivity or any other type of communication links could alternatively be used.

In one embodiment, the message switch 32 is a GL3000 message switch produced by Glenayre Electronics of Duluth, Ga., USA. The message switch 32 translates the notification message into a form acceptable for the transport network to deliver the message body to the appropriate notification devices. In an embodiment of the present invention, the message switch 32 converts the location identifier to one or more device identifiers associated with the location identifier as will be described in detail below. In some embodiments of the present invention, the device identifiers are CAP codes similar to those used by traditional pagers. In this case, each CAP code is assigned to a set of notification devices grouped within a predefined geographical area defined by the location identifier. The message switch 32 could further specify a limited number of base stations for the notification message to be broadcast based upon either the location identifier and/or the device identifier(s) as will be described in more detail below.

In one example, the Glenayre Computer Protocol (GCP) is used for the translation of the notification message. The GCP is supplied by Glenaure Electronics of Duluth, Ga., USA. The GCP is supported by the GL3000 and allows other types of computers to read from and write to the GL3000's subscriber profile. A person skilled in the art will understand that any other device and any other associated protocol, capable of performing the translation of the location identifier could be utilized. Alternatively, as will be described herein below, some embodiments of the present invention do not require such translations.

The encoder 34 is operable to encode the notification message into an acceptable satellite transmission format. In a particular embodiment, the encoder 34 is a GL3000 remote encoder. The satellite uplink 35 is operable to receive the notification message from the encoder 34. In one embodiment, the FLEX (Flexible Wide-area Synchronous Paging) protocol developed by Motorola is used. In another embodiment, the POCSAG (Post Office Code Standardisation Advisory Group) protocol developed by the UK Post Office is used. It should be clear to a person skilled in the art, that any protocol capable of transmitting the notification message from the encoder 34 to the satellite uplink 35 could be used.

The communication satellite 36 is operable to receive the notification message from the satellite uplink 35 and the communication satellite 36 is operable to transmit the notification message to a plurality of base stations 38A,38B. The notification message could be communicated using the FLEX protocol, POCSAG protocol or another protocol that is developed for such purpose. Each base station 38A,38B has a unique base station identifier. As will be described in detail herein below, a set of base station identifiers could be associated with a notification message that limits the geographical extent to which the notification message is transmitted by limiting the base stations within the plurality of base stations that wake-up to transmit the notification message.

It should be understood, although described herein with the encoder 34, satellite uplink 35 and communication satellite 36, that other transport techniques could be used to send the notification message from the message switch 32 to the appropriate base stations 38A,38B. For instance, a form of wireline connections could be used.

The notification devices 40A,40B within the designated location as dictated by the location identifier are operable to receive the notification message from the appropriate base stations 38A,38B. Each notification device 40A,40B has one or more device identifiers associated with it. Each device identifier could be a CAP code, an Electronic Serial Number (ESN) or another device specific identifier. According to some embodiments of the present invention, the device identifiers are programmed within the notification devices and cannot be modified by the user. In this case, the device identifiers are effectively permanently associated with a particular notification device and can only be modified by the service provider.

In some embodiments of the present invention, each notification device 40A,40B is associated with a particular physical location such as a building, house, residence, apartment, etc and is designed to be semi-permanent for this physical location. In a non-limiting example, the notification devices 40A,40B are permanently affixed within the physical location and are permanently wired to the physical location's electrical wiring system.

In one non-limiting example, each notification device could have a plurality of device identifiers programmed, these device identifiers being one permanent ESN and a plurality of CAP codes that could be modified by the service provider (for example up to 15 CAP codes). In another non-limiting example, each notification device could have one or more changeable CAP codes and no permanent device identifier utilized in the scope of the notification system of the present invention. It should be clear to a person skilled in the art, that the number of device identifiers assigned to a particular notification device 40A,40B and the form of the device identifiers could vary and depends on the assignment requirements, as discussed hereinafter.

In a non-limiting example, notification devices physically within the same geographical area as defined by a location identifier will be assigned the same device identifier. This could be based upon a postal code or another system that divides areas by geographical sectors. In cases that notification devices are located in different areas as defined by a location identifier (ex. different postal codes), the notification devices would have at least one device identifier different from one another. Despite having different device identifiers, these same devices could also have at least one device identifier in common that is associated with a location identifier that defines a broader geographical area such as a municipality. Effectively, since each notification device could have more than one device identifier programmed, there could be various sizes of geographical areas defined for a single notification device. For instance, a notification device could be assigned a device identifier for its postal code, for its neighbourhood, for its sector of the city and for the overall municipality. Each of these groupings would include a different range of notification devices having the same device identifiers.

In some embodiments of the present invention, each notification device has one unique device identifier (hereinafter referred to as a primary device identifier) and could have one or more adjustable device identifiers (hereinafter referred to as secondary device identifiers). For instance, the notification device could have one permanent ESN and one or more CAP codes that can be adjusted by the service provider. In this case, the service provider could utilize the primary device identifier as an address to remotely access and download the secondary device identifiers to the particular notification devices. This accessing and downloading function could take the form similar to a notification message directed to the specified primary identifier, but with a format recognized by the notification device as a secondary device identifier programming message (potentially with use of a flag in the message header) and with the notification information being replaced by secondary device identifier information. This modified system has significant advantages in that the geographical areas that will define the various secondary device identifiers can be decided upon and modified after the notification devices have been distributed to the users. This prevents the need for each notification device to be recalled to adjust the geographical areas defined by a particular secondary device identifier. This added feature is particularly advantageous in cases that the notification devices are permanently affixed within a building or residence.

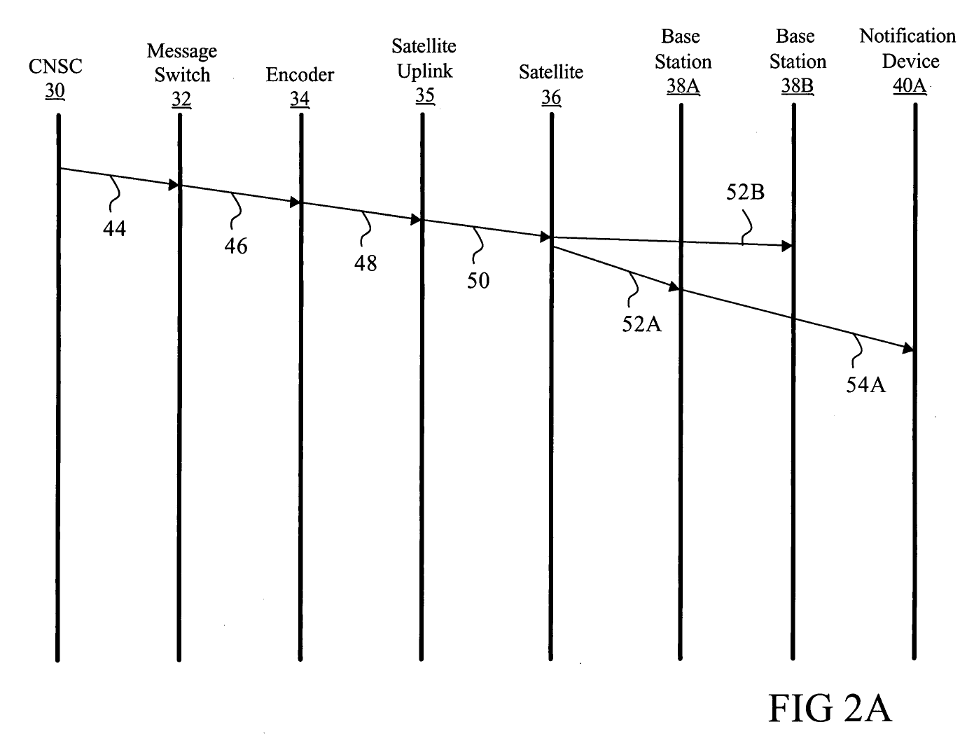

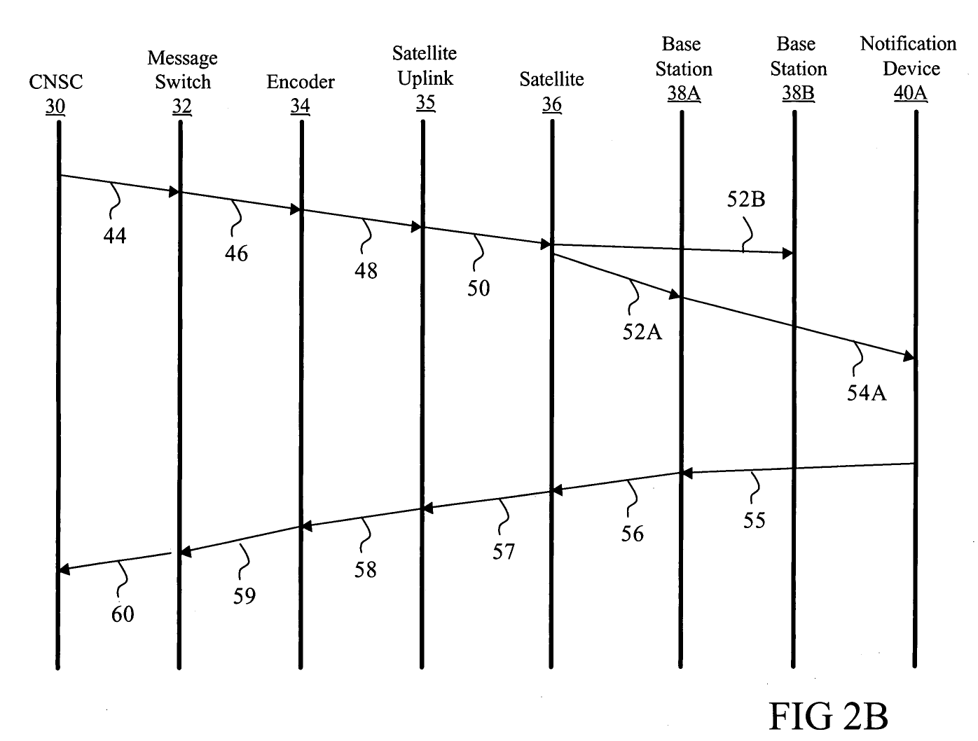

The process of transmitting the notification message from the CNSC 30 to the notification device 40A,40B, according to one embodiment of the present invention, will now be described as a sequence of message streams with reference to FIG. 2A and FIG. 1. The message streams represent a logical flow of information.

The CNSC 30 creates a notification message, containing a message header (including at least one location identifier) and the message body (including notification information such as a text message and a severity indication). It should be understood that the location identifier, notification information and severity indication could alternatively all be within a message body or any other way contained within a notification message. Subsequently, the CNSC 30 sends a message stream 44 to the message switch 32 that contains the notification message. Upon receiving the data stream 44, the message switch 32 translates the message into a recognizable format for the transport network. In one embodiment, this translation could utilize a database lookup including location identifiers and their corresponding one or more device identifiers. In another embodiment, the translation could utilize a database lookup including location identifiers, their corresponding device identifiers and their corresponding one or more base station identifiers. In one embodiment, the resulting notification message could adhere to the Telocator Network Paging Protocol (TNPP).

In a specific non-limiting embodiment, the message switch 32 maintains a database 42 of CAP codes (one example of a device identifier) associated with each of the postal codes in a supported area (one example of a location identifier). For simplicity, the database 42 can be hereinafter referred to as a “device identifier database”. In this particular embodiment, the location identifier is a postal code and the device identifier is a CAP code, but it should be understood that other location identifiers and device identifiers could be utilized. In this case, when the postal codes associated with the affected area are supplied, the message switch 32 queries the device identifier database 42 and identifies the CAP code associated with the supplied postal code. Once the CAP code is identified, the message switch 32 further identifies at least one base station identifier. The identified base stations are the base stations that are to be woken up by the notification message in order to transmit it further to notification devices within their coverage area. In one embodiment, the base station identifier selection is based on the location identifier. In another embodiment, the base station identifier selection is based on the CAP code of the notification device(s) to be activated or alternatively directly based upon the location identifier.

In one non-limiting example as shown with reference to Table 1, each entry in the device identifier database 42 comprises a field for the location identifier and fields for associated device identifiers (in this case CAP codes) and one or more base station identifiers.

TABLE 1

| Location Identifier | Device Identifier | Base station identifier |
|---|---|---|
| KIC 1K5 | 15222356665 | 9665 |
| KIC 3L8 | 34564675789, | 2329 |
| | 34564675790 | |
| KIC 1L8 | 15222365554 | 8666, |
| | | 2342 |
| ABC Street | 34564675789, | 2329, |
| | 34564675790, | 8666, |
| | 15222365554 | 2342 |
| XYZ City | 43254354353 | 9665, |
| | | 2329, |
| | | 8666, |
| | | 2342, |
| | | 3245, |
| | | 7654, |
| | | 9543 |

The example of Table 1 illustrates the flexibility of the approach in which one location identifier could have one or more CAP codes associated with it and one or more base station identifiers. The fourth entry highlights the ability to translate a general location identifier into a plurality of CAP codes and base station identifiers. This fourth entry could alternatively have been implemented with a single CAP code associated with the location identifier, this general CAP code being assigned to each of the notification devices within the broader geographic area (in this example including the postal codes of the second and third entries of Table 1). In this alternative, each of the notification devices could keep a more localized CAP code associated with its postal code. The fifth entry highlights the possibility of a single CAP code being assigned to all the notification devices within a wider geographical area such as a city. In this case, only the one CAP code is assigned to the XYZ City but a plurality of base station identifiers are associated, these base station identifiers being associated with the base stations that provide the coverage area within the XYZ city. In alternative embodiments, a generic base station identifier could be used that wakes-up all of the base stations within a set geographical area in times that a location identifier corresponds to a geographical area larger than the coverage area of a single base station. In some embodiments, this generic base station identifier could be the location identifier or the device identifier.

After translation and transmission to the encoder 34, the encoder 34 sends a message stream 46 to the satellite uplink 35. The satellite uplink 35 is operable to send a message stream 50 to the communication satellite 36. The message streams 48,50, in one embodiment of the present invention, contain the base station identifier(s) of the base stations to be utilized, the device identifier(s) of the notification devices to be awakened, the severity indication and the text message. In one embodiment, the base station identifier(s) and device identifier(s) of the notification devices are within the message header while the severity indication and the text message are contained within the message body.

In one embodiment of the present invention, the communication satellite 36 sends message streams 52A, 52B to all base station 38A,38B. Upon receipt of the message streams 52A,52B, the base stations 38A,38B are operable to analyze the message header of the respective message streams 52A,52B and check the message header for the base station identifier(s). If the base station identifier associated with the particular base station 38A,38B is included in the message header of the message stream 52A,52B, the base station 38A,38B is awoken. If the base station identifier of the particular base station 38A,38B is not specified in the message header of the message stream 52A,52B, the base station 38A,38B is not awoken.

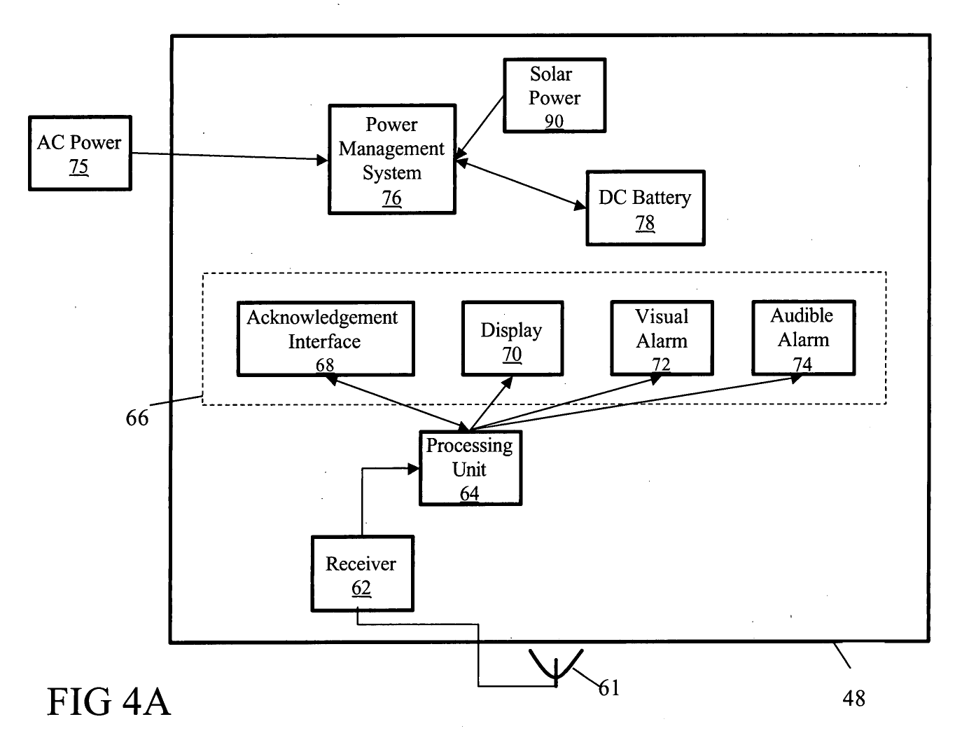

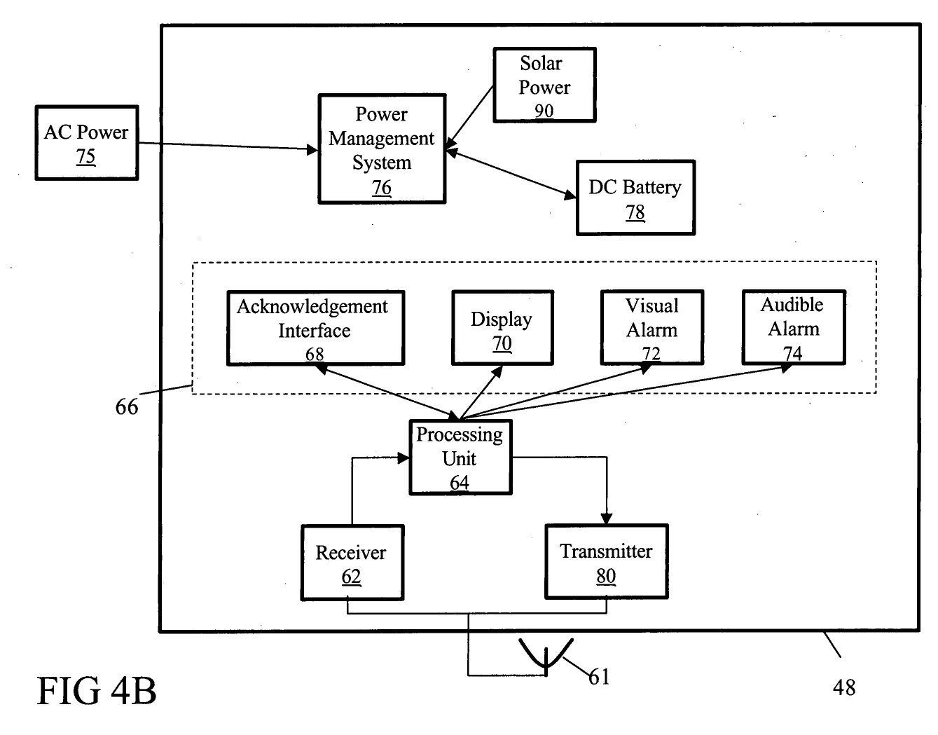

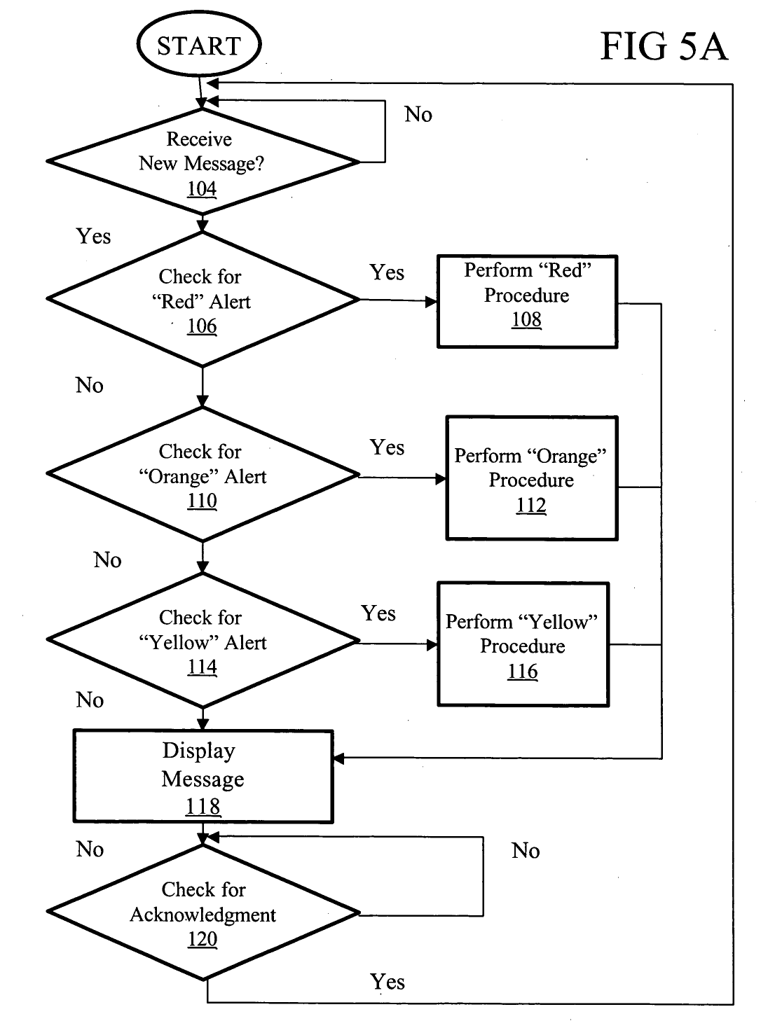

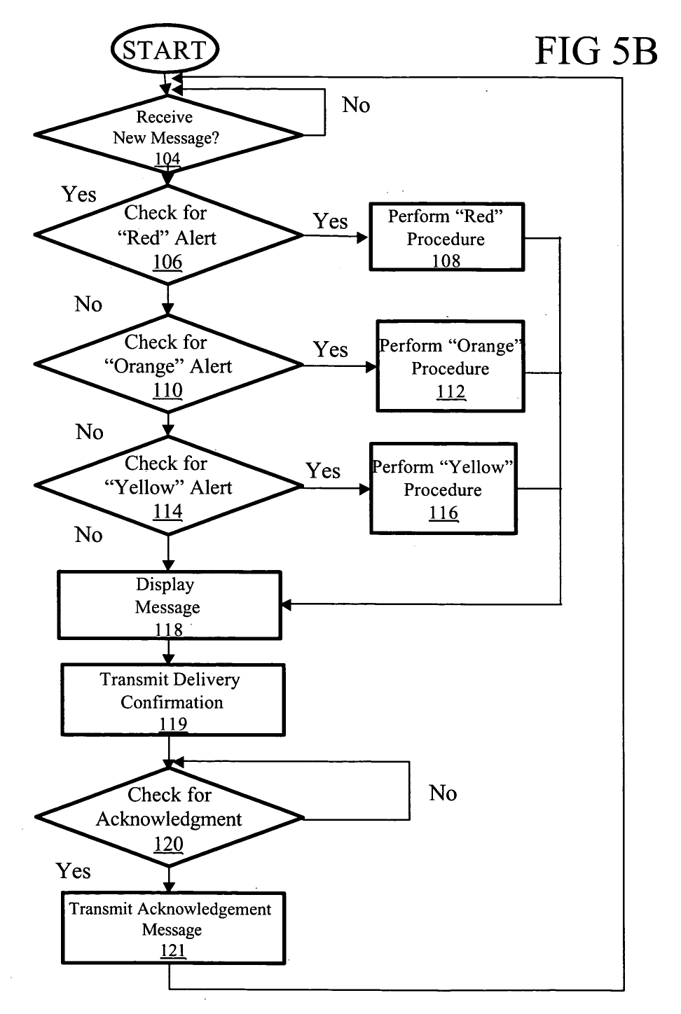

If awoken, the particular base station 38A,38B sends message streams 54A,54B with the specified CAP codes to the notification devices 40A,40B within its coverage area. The notification devices 40A,40B process the header of the notification message within the respective message streams 52A,52B and determine the CAP code(s) associated with the notification message. If the CAP code is one of the CAP codes assigned to the particular notification device 40A,40B, the notification device is awoken and processes the message body as will be described herein below with respect to FIGS. 4A, 4B, 5.

In cases that base station identifiers are not utilized to limit the broadcast of the notification message within the network 28, all base stations that are operable to receive notification messages from the communication satellite 36 will awaken and transmit the notification message to the notification devices within their coverage area.

FIG. 2B depicts the flow of messages between components of FIG. 1 according to another embodiment of the present invention. In a nonlimiting example, upon receipt of and the confirmation of receipt (the process of receipt confirmation is described hereinafter with reference to FIGS. 4A and 4B) of the notification message, the notification device 40A sends a message stream 56 back to the base station 38A. In one embodiment, the message stream 56 comprises a read confirmation. In another embodiment, the message stream 56 comprises the read receipt and the time when the notification message was received by the notification device 40A. In yet another embodiment, the message stream 56 comprises a response from the user of the notification device 40A Once received at the base station 38A, a series of message streams 55,56,57,58,59,60 are generated to communicate the receipt message to the CNSC 30.

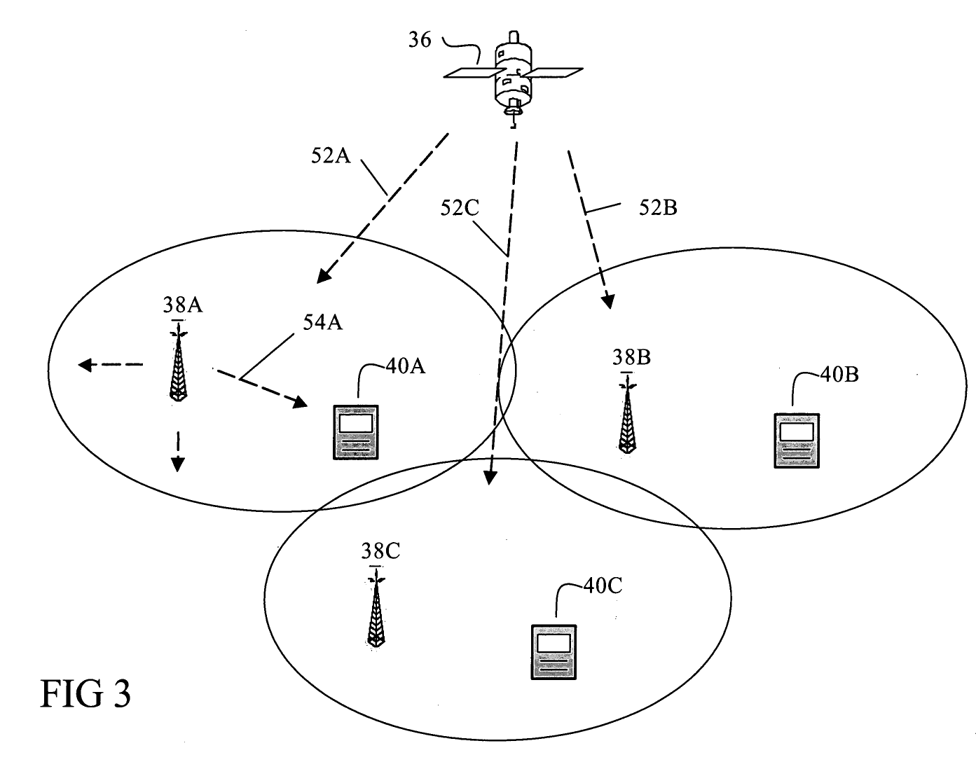

Reference is now made to FIG. 3, which is a pictorial diagram illustrating the flow of messages according to one embodiment of the present invention. The reference to this figure is made to clarify the process of awakening of a particular base station 38A and a particular set of notification devices 40A,40B. In this example, the communication satellite 36 sends a plurality of message streams 52A, 52B, 52C to a plurality of base stations 38A, 38B, 38C. In addition to other information, the message stream 52 comprises the base station identifier. In one example, upon receipt of the message flow 52A the base station 38A verifies whether its base station identifier is specified in the message header of the message stream 58A. If it is identified, the base station 38A is awakened and sends the message stream 54A to the notification devices 40A within its coverage area. Upon receipt of the message flow 52B the base station 38B verifies whether its base station identifier is specified in the message header of the message stream 58B. If it is not identified, the base station 38B is not awakened and does not send the message stream 54B to the notification devices 40B in its coverage area. Hence, if notification device 40B was physically moved from the coverage area of base station 38A to the coverage area of base station 38B by the user, the notification device 40B would not receive notification messages even if one of the device identifiers of the message was assigned to the notification device 40B. This effectively limits the mobility of the notification devices and ensures that if assigned to a particular building, the wireless device remains in the appropriate location.

Reference is now made to FIG. 4A, which depicts block diagrams illustrating the notification device in an embodiment of the present invention. The notification device 48 comprises an antenna. 61, which is operable to receive a message stream from a base station. The antenna 61 is coupled with a receiver 62 operable to send the received message to a processing unit 64. The processing unit 64 is operable to analyse the received message and to communicate with a display 70, a visual alarm 72 and an audible alarm 74. The processing unit 64 is further operable to communicate with an acknowledgment interface 68. The display 70, the visual alarm 72, the audible alarm 74 and the acknowledgment interface 68 are hereinafter jointly referred to as a man-machine interface 66. The notification device 48 further comprises a power supply. In one embodiment of the present invention, the power supply comprises an A/C power source 75, a DC rechargeable battery 78, a solar power panel 90 and a power management system 76 that controls the use of these three sources of power. The A/C power supply 75 is provided from a local power source via a traditional A/C plug or alternatively could be permanently wired into the facilities electrical wiring. The solar power panel 90 is operable to provide back up power in the event of prolonged power outage and in case the DC battery 78 runs out of energy. Further, the solar power panel 90 could be utilized to recharge the DC battery 78. The power management system 76 is coupled to the AC power source 75, the solar power panel 90 and the DC battery 78. The power management system 76 is operable to manage the power flow from the plurality of power sources and to ensure that the power is supplied to sustain prolonged reception and to initiate an alert. It should be clear to a person skilled in the art that any combination of these or any future alternative power supply sources might be used, provided they are capable of providing power for prolonged periods of time.

In one embodiment, the processing unit 64 is a microprocessor, though the processing unit 64 could comprise more than one physical device. It should be clear to a person skilled in the art, that the processing unit 64 may comprise any device, capable of receiving information from the receiver 62 and at least one or more of outputting display data to the display 70, engaging the visual alarm 72, engaging the audible alarm 75 and communicating with the acknowledgment interface 68.

One function of the processing unit 64 is to perform a low-level analysis of the notification message received from its base station and determine if the device identifier is assigned to the particular notification device 48. Only if this assignment search is positive will the notification device 48 awaken and the message body be processed by the processing unit 64.

The man-machine interface 66 represents any suitable means for providing output from the notification device 48A to the notification device 48A user, and for providing inputs from the user to the notification device 48A for acknowledgement (if desired).

The display 70 represents any suitable means for providing written output from the notification device 48A to the notification device 48A user. In one embodiment, the display 70 could be a liquid crystal display. It should be clear to a person skilled in the art, that any other type of displays, capable of outputting alphanumerical messages could be used.

The visual alarm 72 represents any suitable means for providing visual output from the notification device 48A to the notification device 48A user. In one embodiment, the visual alarm 72 consists of three lights—red, yellow and orange. In another embodiment, the visual alarm 72 could be a single LED or a plurality of LED. In yet another embodiment, the visual alarm 72 comprises a flashing light.

The audible alarm 74 represents any suitable means for providing audible output from the notification device 48A to the notification device 48A user. In one embodiment, the audible alarm 74 is a horn. In another embodiment, the audible alarm 74 comprises means for text to voice translation. The means for text to voice translation are operable to translate the written message to an audio message. For instance, if the written message contained words “Danger! Evacuate!”, the means for translating text to voice, would pronounce the words “Danger” and “Evacuate”. It should be clear to a person skilled in the art, that any device, capable of producing a sufficiently loud sound, that must alert people (who could be asleep) of the fact that a notification message has been received, could be used.

The acknowledgment interface 68 could be a button that the user presses in order to acknowledge the receipt of the notification message. Any alternative suitable technique for acknowledgment, such as a switch or voice recognition, could also be used. This acknowledgement could be utilized for internal purposes to trigger the processing unit 64 to stop one or more of the audible alarm 74, the visual alarm 72 and the display 70. Further, as will be described with reference to FIG. 4B the acknowledgement could be used for external purposes as well.

Reference is now made to FIG. 4B that depicts the notification device in another embodiment of the present invention. In this embodiment, the notification device 48 further comprises a transmitter 80. The transmitter 80 is operable to transmit a confirmation message back to the CNSC 30 as described previously with reference to FIG. 2B.

Reference is now made to FIG. 5A which depicts a flow diagram of a method 100 for receiving and processing a notification message within a notification device 40 according to one embodiment of the present invention. The method 100 at step 104 queries if a new notification message has been received at the notification device 40. If no notification messages have been broadcast (step 104=NO), the method 100 continues to monitor for notification messages broadcast to the notification device.

If the query is positively answered (step 104=YES), i.e. if the notification message has been broadcast and received and the associated device identifier is assigned to the particular notification device, then the method 100 proceeds to steps 106 to 114, in which it is determined whether a severity indication is within the message body. As discussed above, in one particular embodiment, code “red”, “orange” and 37 yellow” are used as severity indications. In step 106, the method 100 queries if the “red” code is indicated in the message body of the notification message. Alternatively, this indication could be in the message header or n a different format. If the query is negatively answered (step 106NO), the method 100 proceeds to step 110. If the query is positively answered (step 106=YES), the method 100 proceeds to step 108 in which a red alert procedure is triggered. In a non-limiting example, this red alert procedure could comprise steps of switching the visual display 72 onto a red level and activating the audible alarm 74 continuously. It should be clear to a person skilled in the art that any combination of audible, visual and vibrating means could be used. The method 100 subsequently proceeds to step 118.

In step 110, the method 100 queries if the “orange” code is indicated in the message body of the notification message. If the query is negatively answered (step 100=NO), the method 100 proceeds to step 114. If the query is positively answered (step 110=YES), the method 100 proceeds to step 112 and an orange alert procedure is triggered. In a non-limiting example, this orange alert procedure could comprise the step of switching the visual display 72 onto an orange level and activating the audible alarm 74 for a limited time period. It should be clear to a person skilled in the art that any combination of audible, visual and vibrating means could be used. The method 100 then proceeds to step 118.

In step 114, the method 100 queries if the “yellow” code is indicated in the message body of the notification message. If the query is negatively answered (step 114=NO), the method 100 proceeds to step 118. If the query is positively answered (step 114=YES), the method 100 proceeds to step 1I 6 in which a yellow alert procedure is triggered. In a non-limiting example, this yellow alert procedure could comprise the step of switching the visual display 72 onto a yellow level. It should be clear to a person skilled in the art that any combination of audible and visual means could be used. The method 100 then proceeds to step 118.

At step 118, the method 100 triggers the activation of the display 70. In this step the written message is displayed. In one case, the written message could contain the proposed course of action, for example a “red” alarm could be: “Chemical spill Emergency! Evacuate the area immediately and proceed to School X!” In another case, the written message could contain a message during a blackout, for example a yellow alarm could be “Source of blackout being investigated—please standby”.

In one embodiment, the method 100 subsequently proceeds to step 120 in which it is determined whether a receipt of the message has been acknowledged with the acknowledgment interface 68. If the query is answered positively (step 120=YES), the method 100 disengages one or more outputs of the man machine interface 66 (potentially leaving the displayed text message). The method 100 then returns to step 102 and continues to monitor for new notification messages. If the query is negatively answered (step 120=NO), i.e. the end user has not acknowledged receipt of the notification message, the man-machine interface continues to deliver the message. It should be clear to a person skilled in the art, that other means of acknowledging the receipt of the notification message could be utilized. For instance, a timeout could be used that could eliminate the need for the acknowledgement interface and hence make the notification device less expensive.

A modified method is now described with reference to FIG. 5B for receiving and processing a notification message within a notification device 40 according to an alternative embodiment of the present invention. In this embodiment, the notification device 40 is as described with respect to FIG. 4B. As shown, the method 100b, after step 118, triggers the transmission, at step 119, of a delivery confirmation message to the base station and eventually to the CNSC 30 utilizing the transmitter 80. The delivery confirmation message is an indication that the notification device 40 has received the notification message and has successfully processed it. Further, after step 120, the method 100b triggers the transmission, at step 121, of an acknowledgement message to the base station and eventually to the CNSC 30 utilizing the transmitter 80. The acknowledgement message is an indication that the user of the notification device 40 has received and acknowledged the notification message.

Although the above steps have been described in a particular order and for a particular embodiment, it is to be understood by a person skilled in the art, that the invention is not limited thereto. Similar results could occur with different severity indications and different orders of steps.

Although described above with reference to a transport network including an encoder, a satellite uplink, a communication satellite and a plurality of base stations, it should b understood that other transport networks could be utilized. For instance, a transport network with a direct links between the message switch and a plurality of base stations could allow for the translated notification messages to be received at base stations without utilizing a communication satellite.

Although a message switch is described above for translation of the notification message, it should be understood that any apparatus that allows translation of the location identifier(s) to corresponding device identifier(s) and possibly base station identifiers could be utilized. This could be a dedicated hardware and/or software component and in an alternative embodiment could be integrated with the CNSC. In fact, in some embodiments of the present invention, the interface within the CNSC allows the user to input one or more device identifiers directly within the original notification message that is generated, therefore removing the need for translation in a translation apparatus such as the message switch 32 of the location identifier(s) into the device identifier(s). In this case, effectively the device identifiers themselves become the location identifiers and the location identifiers are programmed within the notification devices.

In one non-limiting example, the location identifiers are the same as the device identifiers within the notification system and no translation is necessarily required. Further, even the base station identifiers could be represented with the location identifiers. In this case, a single location identifier is programmed within a set of notification devices as one of their device identifiers and the same location identifier is programmed into one or more of the base stations as at least one of their base station identifiers. In this case, the location identifier could take the form of a postal code, a numeric version of a postal code, a CAP code or another format programmed within the various devices as a location identifier. If a location identifier is entered within the CNSC with corresponding notification information, a notification message is generated including the location identifier and the notification information. The base station(s) with the location identifier as a base station identifier are awoken and transmit the notification message to their respective coverage areas and the notification devices within these coverage areas that have the location identifier as a device identifier process the notification information after receiving the notification message.

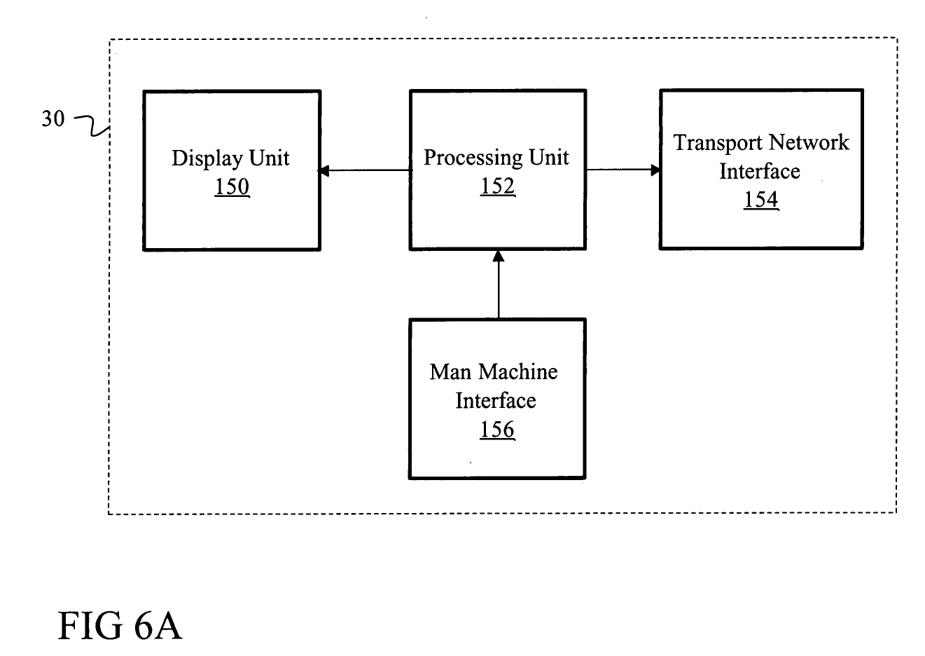

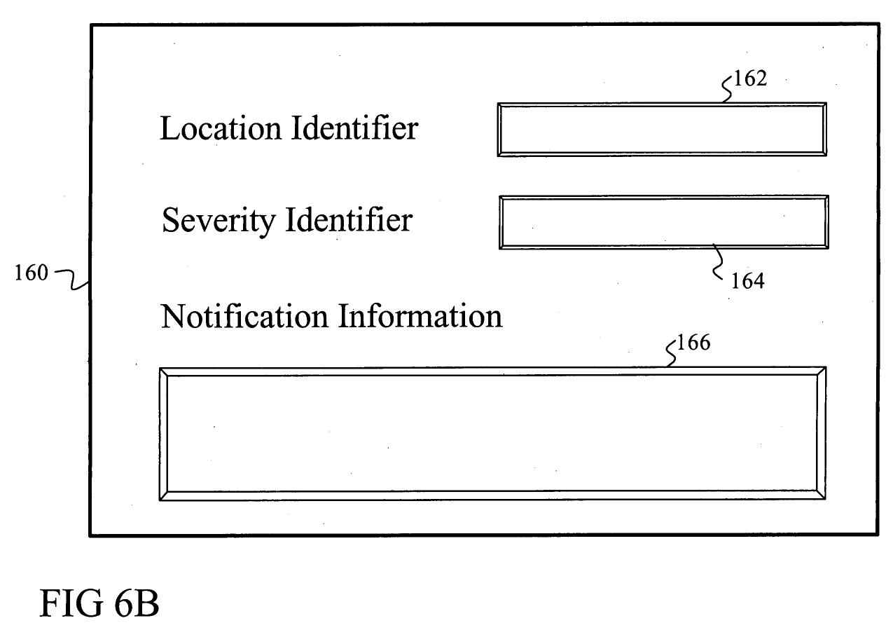

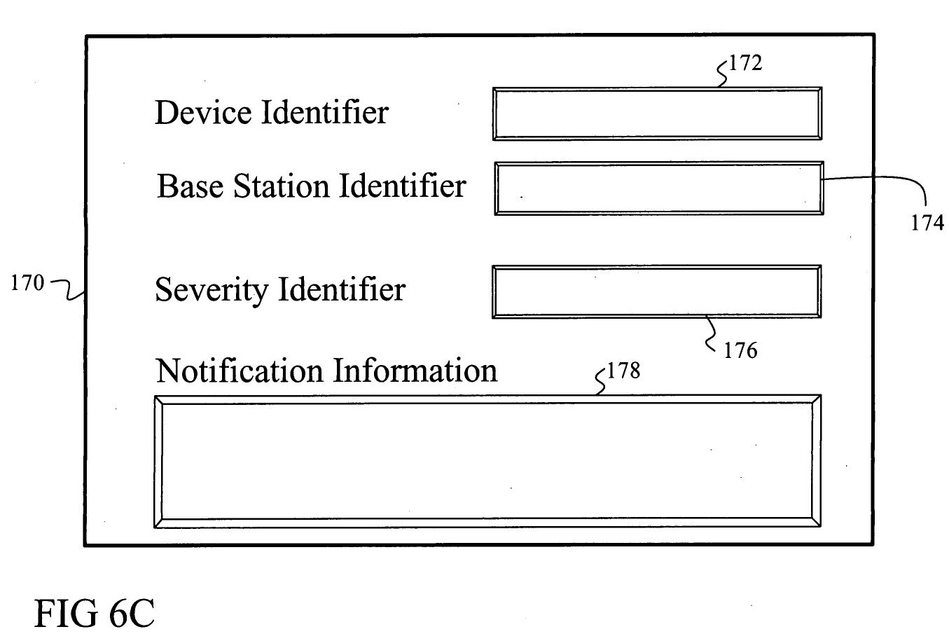

Two embodiments of the CNSC 30 are now described with reference to FIGS. 6A, 6B and 6C. FIG. 6A illustrates the physical components of the CNSC 30 according to one embodiment of the present invention. In this case, the CNSC 30 comprises a display unit 150, a man machine interface 156, a transport network interface 154 and a processing unit 152 coupled to the other three components 150,154,156. In this embodiment, the processing unit provides a Graphical User Interface (GUI) to the display unit and the user of the CNSC 30 inputs information via the man machine interface 156 in response to the GUI. The man machine interface 156 could comprise a keyboard and a mouse or alternative interface devices such as a touch screen on the display 150. The processing unit 152 receives the information from the man machine interface 156 and generates the initial notification message incorporating this information (described in more detail for two embodiments with respect to FIGS. 6B and 6C). The resulting notification message is output to the transport network interface 154 for transmission to a transport network such as described previously corresponding to components 32,34,35,36,38A,38B which will allow delivery of the notification message to a set of notification devices dictated by the processing unit 152.

FIGS. 6B and 6C depict two embodiments for the GUI to be displayed on display unit 150. GUI 160 is illustrated on FIG. 6B and includes a location identifier interface 162, a severity indication identifier 164 and a notification information interface 166. GUI 170 is illustrated on FIG. 6C and includes a device identifier interface 172, a base station identifier interface 174, a severity indication identifier 176 and a notification information interface 178. These interfaces are illustrated as text based entries within a web portal, though one skilled in the art should understand that there are numerous manners to implement such interfaces. For instance, these identifiers could have a preset selection of inputs that the user simply scrolls through. Alternatively for some interfaces, such as the location identifier interface 162, a map could be utilized in which the user selects geographical areas to receive the notification information. It should be understood that there are numerous other interface possibilities that further do not utilize a web portal as illustrated.

In one non-limiting example, the man machine interface 156 is a map interface which allows the user to highlight the geographical areas of focus for the notification information. In this case, the processing unit 152 detects the areas that have been highlighted using a sensor pad and translates the geographical area of focus into one or more location identifiers using a database lookup table linked to the XY coordinates highlighted on the map. These location identifier(s) are input within the resulting notification message. Alternatively, the processing unit 152 could translate the geographical area of focus directly into one or more device identifiers corresponding to the notification devices within the geographical area of focus and possibly even the base station identifiers corresponding to base stations that provide wireless coverage to the geographical area of focus.

The present invention thus provides an apparatus and a method of wireless notification. The system of the present invention bypasses the PSTN and utilizes device identifiers, such as CAP codes, rather than telephone numbers to identify notification devices. This ensures that in times of emergency, when the PSTN tends to be over-loaded, the notification message can still be delivered to the appropriate notification devices. The simple notification devices within embodiments of the present invention further ensure that the end user is unable to interfere with the settings of the device identifier(s) (e.g. CAP codes) in order to ensure that only qualified personnel of the service provider can assign them. This is particularly important, considering the nature of notification messages and importance of delivering the notification message to each and every appropriate notification device in times of emergency. Yet further, some embodiments of the present invention limit the ability of the user to move the notification device by limiting the number of base stations that transmit the notification message. This could be advantageous in cases that the notification device is assigned to a particular building or residence.

Persons skilled in the art will appreciate that there are yet more alternatives implementations and modifications possible for implementing the present invention, and that the above implementation is only an illustration of this embodiment of the invention. The scope of the invention, therefore, is only to be limited by the claims appended hereto.

1. A system for delivering notification information to a set of notification devices, the system comprising:
a notification message apparatus operable to generate and transmit a notification message comprising at least one device identifier and notification information, each device identifier being allocated to a set of notification devices assigned within a geographical area;
a transport network, coupled to the notification message apparatus, operable to receive the notification message and to transmit the notification message to a wireless coverage area; and
a set of notification devices within the wireless coverage area operable to receive the notification message from the transport network and to process the notification information if one of the at least one device identifier corresponding to the notification message is allocated to the particular set of notification devices.

2. A system according to claim 1, wherein the transport network comprises a plurality of base stations, each base station having a corresponding base station identifier;
wherein the notification message further comprises a set of base station identifiers that collectively define the wireless coverage area of the transport network for transmitting the translated notification message;
whereby the notification information is not transmitted by all base stations within the transport network and only by a select set of base stations that limits the geographical area of the transmission.

3. A system according to claim 2, wherein the notification message comprises a message header and a message body, the message header comprising the at least one device identifier and the set of base station identifiers and the message body comprising the notification information.

4. A system according to claim 2, wherein the set of base station identifiers comprise at least one base station identifier.

5. A system according to claim 1, wherein the transport network comprises a plurality of base stations, each base station having a corresponding base station identifier; and
wherein the system further comprises a base station allocation apparatus operable to receive the notification message, to determine a set of base station identifiers that collectively define the wireless coverage area of the transport network for transmitting the notification message and to input the set of base station identifiers into the notification message;
whereby the notification information is not transmitted by all base stations within the transport network and only by a select set of base stations that limits the geographical area of the transmission.

6. A system according to claim 1, wherein the set of notification devices comprises at least one notification device.

7. A system according to claim 1, wherein the at least one device identifier allocated to the set of notification devices cannot be modified by the users of the notification devices.

8. A system according to claim 1, wherein each of the notification devices within the set of notification devices are allocated a plurality of device identifiers; for each notification device, the allocated device identifiers representing a plurality of geographical areas in which the notification device is physically located.

9. A system according to claim 1, further comprising a remote device identifier allocation apparatus operable to transmit, via the transport network, at least one device identifier to at least one notification device of the set of notification devices in order to allocate the at least one device identifier to the notification device.

10. A system according to claim 9, wherein the at least one notification device of the set of notification devices is allocated a primary device identifier; and
wherein the device identifier allocation apparatus allocates the at least one device identifier to the notification device utilizing the primary device identifier.

11. A system according to claim 10, wherein the primary device identifier is a permanent identifier for the notification device.

12. A system according to claim 1, wherein the at least one device identifier is at least one CAP code.

13. A system according to claim 1, wherein the notification information is a text-based message.

14. A system according to claim 13, wherein the processing the notification information by each of the notification device within the set of notification devices comprises displaying the text message on a display local to the notification device.

15. A system according to claim 1, wherein the notification information is a text-to-audio message.

16. A system according to claim 1, wherein the notification information is an audio message.

17. A system according to claim 1, wherein the notification message comprises a severity indication that indicates one of a plurality of levels of severity of the notification information; and
wherein the processing of the notification message by each of the notification device within the set of notification devices is based upon the level of severity of the notification information.

18. A system according to claim 1, wherein the notification devices within the set of notification devices each comprise a display and at least one of an audible alarm and a visual alarm; and
wherein the processing of the notification message by each of the notification device within the set of notification devices comprises displaying the notification information on the display and at least one of triggering the audible alarm and the visual alarm.

19. A system according to claim 18, wherein the notification message comprises a severity indication that indicates one of a plurality of levels of severity for the notification information; and
wherein the processing of the notification message by each of the notification device within the set of notification devices comprises displaying the notification information on the display and selectively triggering the audible alarm and the visual alarm based upon the severity indication.

20. A system according to claim 18, wherein the notification devices within the set of notification devices each further comprise an acknowledgement interface; and
wherein the set of notification devices are further operable to continue at least one of the displaying of the notification information, the audible alarm and the visual alarm until the user of the notification device triggers the acknowledgement interface.

21. A system according to claim 20, wherein the set of notification devices are further operable to transmit an acknowledgement receipt to a remote location upon the user trigging the acknowledgement interface.

22. A system according to claim 1, wherein at least one of the notification devices within the set of notification devices comprises a plurality of power supply sources and a power supply management apparatus operable to control the supply of power to the notification device from the plurality of power supply sources.

23. A system according to claim 22, wherein the plurality of power supply sources comprises a plurality of the set of a solar power source, a battery source and an alternating current source.

24. A method for delivering notification information to a set of notification devices, the method comprising:
generating a notification message comprising at least one device identifier and notification information, each device identifier being allocated to a set of notification devices assigned within a geographical area;
transmitting the notification message to a wireless coverage area;
receiving the notification message at the set of notification devices; and
processing the notification information at each of the notification devices if one of the at least one device identifier corresponding to the notification message is allocated to the particular notification device.

25. A method according to claim 24, wherein the notification message further comprises a set of base station identifiers that collectively define the wireless coverage area of the transmitting of the notification message;
wherein the transmitting the notification message comprises transmitting the notification message to a plurality of base stations corresponding to the set of base station identifiers, and further transmitting the translated notification message within the coverage area of said base stations;
whereby the notification information is not transmitted by all potential base stations and only by a select set of base stations that limits the geographical area of the transmission.

26. A system for delivering notification information to a set of notification devices, the system comprising:
a translation apparatus operable to receive a notification message comprising at least one location identifier and notification information; to determine, for each of the at least one location identifiers, at least one corresponding device identifier, each device identifier being allocated to a set of notification devices assigned within a geographical area defined by the location identifier; and to generate a translated notification message comprising the at least one device identifier and the notification information;
a transport network, coupled to the translation apparatus, operable to transmit the translated notification message to a wireless coverage area; and
a set of notification devices within the wireless coverage area operable to receive the translated notification message from the transport network and to process the notification information if one of the at least one device identifiers within the translated notification message is allocated to the particular set of notification devices.

27. A system according to claim 26, wherein the transport network comprises a plurality of base stations, each base station having a corresponding base station identifier;
wherein the translation apparatus is further operable to determine, for each of the at least one location identifiers, a set of base station identifiers that collectively define the wireless coverage area of the transport network for transmitting the translated notification message; and wherein the translated notification message further comprises the set of base station identifiers;
whereby the notification information is not transmitted by all base stations within the transport network and only by a select set of base stations that limits the geographical area of the transmission.

28. A system according to claim 27, wherein the notification message comprises a message header and a message body, the message header comprising the location identifier and the message body comprising the notification information; and
wherein the translated notification message comprises a translated message header and said message body, the translated message header comprising the at least one device identifier and the set of base station identifiers.

29. A system according to claim 27, wherein the set of base station identifiers comprise at least one base station identifier.

30. A system according to claim 26, wherein the set of notification devices comprises at least one notification device.

31. A system according to claim 26, wherein the at least one device identifier allocated to the set of notification devices cannot be modified by the users of the notification devices.

32. A system according to claim 26, wherein each of the notification devices within the set of notification devices are allocated a plurality of device identifiers; for each notification device, the allocated device identifiers representing a plurality of geographical areas in which the notification device is physically located.

33. A system according to claim 26, further comprising a device identifier allocation apparatus operable to transmit, via the transport network, at least one device identifier to at least one notification device of the set of notification devices in order to allocate the at least one device identifier to the particular notification device.

34. A system according to claim 26, further comprising a remote device identifier allocation apparatus operable to transmit, via the transport network, at least one device identifier to at least one notification device of the set of notification devices in order to allocate the at least one device identifier to the notification device.

35. A system according to claim 34, wherein the at least one notification device of the set of notification devices is allocated a primary device identifier; and
wherein the device identifier allocation apparatus allocates the at least one device identifier to the notification device utilizing the primary device identifier.

36. A system according to claim 35, wherein the primary device identifier is a permanent identifier for the notification device.

37. A system according to claim 26, wherein the at least one device identifier is at least one CAP code.

38. A method for delivering notification information within a set of notification devices, the method comprising:
receiving a notification message comprising at least one location identifier and the notification information;
translating each of the at least one location identifiers into at least one device identifier in order to generate a translated notification message, each device identifier being allocated to a set of notification devices assigned within a geographical area defined by the location identifier;
transmitting the translated notification message to a wireless coverage area;
receiving the translated notification message at a set of notification devices within the wireless coverage area; and
processing the notification information if one of the at least one device identifiers corresponding to the notification message is allocated to the particular set of notification devices.

39. A method according to claim 38, wherein the translating the at least one location identifier further comprises determining, for each of the at least one location identifiers, a set of base station identifiers that collectively define the wireless coverage area of the transport network for transmitting the translated notification message; and wherein the translated notification message further comprises the set of base station identifiers;
wherein the transmitting the translated notification message to a wireless coverage area comprises transmitting the translated notification message to a plurality of base stations corresponding to the set of base station identifiers, and further transmitting the translated notification message within the coverage area of said base stations;
whereby the notification information is not transmitted by all potential base stations and only by a select set of base stations that limits the geographical area of the transmission.

40. An apparatus for translating notification messages comprising:
a first interface operable to receive a notification message comprising at least one location identifier and the notification information;
a processing unit operable to determine, for each of the at least one location identifiers, at least one corresponding device identifier, each device identifier being allocated to a set of notification devices assigned within a geographical area defined by the location identifier; and to generate a translated notification message comprising the at least one device identifier and the notification information; and
a second interface operable to output the translated notification message to a set of notification devices within a wireless coverage area.

41. An apparatus according to claim 40, wherein the first and second interfaces are integrated within a single interface.

42. An apparatus for generating notification messages to be transmitted to a set of notification devices, the apparatus comprising:
a notification information interface operable to receive notification information;
a device identifier interface operable to receive at least one device identifier, each device identifier being allocated to a set of notification devices assigned within a geographical area;
a processing unit operable to generate a notification message comprising the notification information and the at least one device identifier; and
an output interface operable to output the notification message to a transport network for delivery to the set of notification devices corresponding to the at least one device identifier.

43. An apparatus according to claim 42, wherein the notification information interface and the device identifier interface are integrated within a single interface.

44. An apparatus according to claim 42, further comprising a base station identifier interface operable to receive a set of base station identifiers that collectively define a wireless coverage area for transmitting the notification message;
wherein the notification message generated by the processing unit further comprises the set of base station identifiers.

45. An apparatus according to claim 42, further comprising a severity indication interface operable to receive a severity indication that indicates one of a plurality of levels of severity for the notification information;
wherein the notification message generated by the processing unit further comprises the severity indication

46. An apparatus according to claim 42, wherein the device identifier interface comprises a map interface operable to receive information concerning a geographical area of focus for the notification information; and
wherein the processing unit is further operable to translate the information concerning the geographical area of focus into the at least one device identifier, the at least one device identifier being allocated to a set of notification devices assigned within a geographical area associated with the geographical area of focus.

47. A method for generating notification messages to be transmitted to a set of notification devices, the method comprising:
receiving notification information;
receiving at least one device identifier, each device identifier being allocated to a set of notification devices assigned within a geographical area;
generating a notification message comprising the notification information and the at least one device identifier; and
outputting the notification message to a transport network for delivery to the set of notification devices corresponding to the at least one device identifier.

48. An apparatus for generating notification messages to be transmitted to a set of notification devices, the apparatus comprising:
a notification information interface operable to receive notification information;
a location identifier interface operable to receive at least one location identifier, each location identifier defining a geographical area in which a set of notification devices are assigned;
a processing unit operable to generate a notification message comprising the notification information and the at least one location identifier; and
an output interface operable to output the notification message to a transport network for delivery to the set of notification devices within the geographical area defined by the at least one location identifier.

49. An apparatus according to claim 47, wherein the notification information interface and the location identifier interface are integrated within a single interface.

50. An apparatus according to claim 47, further comprising a severity indication interface operable to receive a severity indication that indicates one of a plurality of levels of severity for the notification information;
wherein the notification message generated by the processing unit further comprises the severity indication.

51. An apparatus according to claim 47, wherein the location identifier interface comprises a map interface operable to receive information concerning a geographical area of focus for the notification information; and
wherein the processing unit is further operable to translate the information concerning the geographical area of focus into the at least one location identifier, the at least one location identifier being defined for a geographical area associated with the geographical area of focus.

52. A method for generating notification messages to be transmitted to a set of notification devices, the method comprising:
receiving notification information;
receiving at least one location identifier, each location identifier defining a geographical area in which a set of notification devices are assigned;
generating a notification message comprising the notification information and the at least one location identifier; and
outputting the notification message to a transport network for delivery to the set of notification devices within the geographical area defined by the at least one location identifier.

53. A system for remotely assigning a device identifier to A least one notification device, the system comprising:
a device identifier allocation apparatus operable to generate and transmit a device identifier message comprising at least one primary device identifier associated with a predetermined notification device and at least one secondary device identifier allocated to a geographical area in which the predetermined notification device is located;
a transport network, coupled to the device identifier allocation apparatus, operable to receive the device identifier message and to transmit the device identifier message to a wireless coverage area; and
at least one notification device within the wireless coverage area operable to receive the device identifier message from the transport network and to allocate the at least one secondary device identifier to the notification device if the notification device is allocated the primary device identifier.

54. A system according to claim 53, wherein the at least one secondary device identifier comprises a plurality of secondary device identifiers, each secondary device identifier being allocated to a geographical area in which the predetermined notification device is located.

55. A method for assigning device identifiers to at least one notification device, the method comprising:
generating a device identifier message comprising at least one primary device identifier associated with a predetermined notification device and at least one secondary device identifier allocated to a geographical area in which the predetermined notification device is located;
transmitting the device identifier message to at least one notification device within a wireless coverage area; and
allocating the at least one secondary device identifier to the notification device if the notification device is allocated the primary device identifier.

56. A method according to claim 55, wherein the at least one secondary device identifier comprises a plurality of secondary device identifiers, each secondary device identifier being allocated to a geographical area in which the predetermined notification device is located.
